(19) United States
(12) Patent Application Publication
(10) Pub. No.: US 2019/0108430 A1
(43) Pub. Date: Apr. 11, 2019

(54) SYSTEM AND METHOD FOR ISSUING QUICK RESPONSE CODE

(71) Applicant: Youdentify LLC, Timnath, CO (US)

(72) Inventor: David Coppedge, Timnath, CO (US)

(21) Appl. No.: 16/153,974

(22) Filed: Oct. 8, 2018

Related U.S. Application Data
(60) Provisional application No. 62/582,204, filed on Nov. 6, 2017.
(60) Provisional application No. 62/569,273, filed on Oct. 6, 2017.

(51) Int. Cl. G06K 19/06; G06K 7/14; G06F 17/30

(52) U.S. Cl. CPC G06K 19/06037; G06F 17/30879; G06K 7/1417

(57) ABSTRACT

A quick response code system and methods of associating a quick response code with an item of interest are the subject of the present disclosure. In one embodiment, the system includes a code generation tool and an information modification tool. The code generation tool is configured to generate a quick response code that associates the item of interest with a record in a data repository, while the information modification tool that allows a user to access, view and modify information associated with the record. According to varying embodiments, the system prompts a first user to share the quick response code and the associated record with a second user.

### CROSS-REFERENCE TO RELATED APPLICATION

This application claims priority to and the benefit under 35 U.S.C. § 119(e) to U.S. Provisional Patent Application Ser. Nos. 62/569,273 and 62/582,204 filed Oct. 6, 2017 and Nov. 6, 2017, respectively. The foregoing applications are incorporated by reference herein in their entireties.

### FIELD OF THE INVENTION

The present invention is generally directed toward systems and methods for supplying quick response codes or other coded information for use in public, private or semi-private settings.

### COPYRIGHT NOTICE

A portion of this disclosure, including any applications incorporated by reference herein and their Appendices, is subject to copyright protection. Limited permission is granted to facsimile reproduction of the patent document or patent disclosure as it appears in the U.S. Patent and Trademark Office (USPTO) patent file or records. The copyright owner reserves all other copyright rights whatsoever.

### BACKGROUND

A Quick Response code is a matrix-type or two-dimensional (i.e., comprising both horizontal and vertical components) machine-readable barcode, which is commonly referred to as a QR code. QR codes and other optically-coded labels frequently contain information about an item to which the coded label is attached. QR codes may be read by a variety of devices, such as the camera on a mobile device, and data associated with the QR code may then be extracted.

Such codes typically direct an individual to a specific server, and provide information about a company, product, service, event, etc. However, there is presently no system or method for a user to receive a “blank” QR code, associate the QR code with an item of interest to the user, link the QR code to a public, private or semi-private data repository, access, view and modify information associated with the item of interest, and/or transfer the QR code to another user who has interest in the item. Thus, many QR codes are limited with respect to their applicability to particular items of interest, the ability of a user to associate content of a more personal nature (including by way of example, personal audio and/or video files), and the ability of one or more users to modify the information associated with a particular code. In use, QR codes are therefore short lived and non-transferable from the user who assigned the code.

In addition to these shortcomings, there is presently no system or method which provides an application, operable on machine-readable media, for QR and equivalent codes to be issued in a form that allows the user to first identify an item of interest, obtain a unique code (for example, through the application), assign the unique code to the item of interest, associate the code with at least one data repository, store information related to the item of interest in the data repository, share information related to the item of interest with others and, in certain instances, permit others to modify or add content to the information stored in the data repository, and if necessary transfer the code and associated information to another. Furthermore, there are no systems or methods for permitting a user to remove, reuse or reassign a QR code or information associated with a previously issued QR code, such that a user may associate a previously issued QR code with a new item of interest.

It is with respect to the above issues and other problems presently faced by those of skill in the pertinent art that the embodiments presented herein were contemplated. The present invention solves the problems associated with the prior art and provides an apparatus and method for receiving a “blank” QR code that can be affixed upon an item of interest to the user, linking the QR code to a public, private or semi-private data repository, accessing, viewing and modifying information associated with the item of interest as needed, and/or transferring the QR code to another user who has interest in the item. Other advantages and benefits will become apparent after reviewing the Summary and Detailed Description sections below.

### SUMMARY OF THE INVENTION

Accordingly, the present disclosure relates to systems and methods that overcome the problems identified above. While several advantages of the system and method of one embodiment are provided in this section, this Summary is neither intended nor should it be construed as being representative of the full extent and scope of the present invention. The present invention is set forth in various levels of detail in the Summary as well as in the attached drawings and in the Detailed Description, and no limitation as to the scope of this disclosure is intended by either the inclusion or non-inclusion of elements, components, etc. in the Summary. Additional aspects of the present disclosure will become more readily apparent from the materials included in the Detailed Description below.

In view of the shortcomings in the prior art, it is one aspect of the present disclosure to provide a user with a system for claiming a unique QR code, and linking that QR code to an item of interest to the user. According to one embodiment, unique QR codes are not assigned to any specific user until a user claims a code and stores header information to the unique code.

In one embodiment, a user may claim a code by purchasing a code through an application stored on machine-readable media and accessible through a user mobile device. In another embodiment, a user may claim one or a plurality of codes by accessing the codes through the application and printing those codes for the user's personal use. Whether the user prints codes or purchases codes through the application described herein, the codes are open for any user to claim. Nearly an infinite number of unique codes may be maintained by the application.

It is yet another aspect to provide a user with a method for obtaining one or more QR codes and associating one or more QR codes with an item of personal interest to a user. It is yet another aspect to provide a method for issuing and assigning QR codes to an item of personal interest, and then adding or modifying information linked to the particular QR codes, including through the application described herein.

In another embodiment, a user may share the content of a claimed QR code with another user or transfer a claimed QR code to a new owner via email or otherwise. Once shared, the other user may view the QR code, and, dependent upon settings selected by the user, add, edit or delete content from the QR code. Upon transfer of the QR code to the new owner, any sharing of the QR code will be revoked, and the original owner shall not be able to access the QR code again, unless the new owner provides the original owner with access to the QR code after the transfer.

In yet a further aspect of the present disclosure, a computer readable storage medium comprising processor executable instructions operable to utilize the system or perform the methods described both above and below is provided.

In one embodiment, a user is provided with a novel method for associating a QR code with an item and storing information with the item by following one or more of the steps of (1) accessing at least one code from a repository of codes, (2) downloading or printing at least one code from the repository, (3) associating header information with the at least one code, (4) associating an image, name and/or description of an item for the at least one code, (5) assigning the at least one code to one or more categories, (6) selecting at least one public/private/semi-private setting for the at least one code, and (7) saving the information associated with the at least one code in a user-selected data repository.

In one embodiment, a user may be provided with further method steps associated with the QR code associated with an item, including (8) modifying the information associated with the at least one code, (9) changing the setting for the at least one code to enable sharing of content associated with the at least one code, (10) copying and/or transferring information associated with at least one code to at least one other code, (11) permitting sharing of select content associated with the at least one code, (12) supplementing the information associated with the at least one code, (13) editing information associated with the at least one code, and (14) performing diagnostics and/or repair functions with respect to the information associated with the at least one code. Variations on these embodiments are contemplated, as is the order of the foregoing steps, and are further illustrated in the detailed description below.

It is to be expressly understood that the ensuing description provides embodiments only, and is not intended to limit the scope, applicability, or configuration of the invention. Rather, this summary will provide those skilled in the art with an enabling description for implementing the embodiments. It should be understood that various changes may be made in the function and arrangement of elements without departing from the spirit and scope of the appended claims.

Furthermore, while embodiments of the present disclosure will be described in connection with various examples of QR codes, it should be appreciated that embodiments of the present disclosure are not limited to any particular style of label or coded image. In addition, while embodiments of the present invention may be described with respect to an item of personal property, other applicability is contemplated.

Several terms used herein are intended to be understood according to their plain and ordinary meaning. The term “machine-readable media” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a flexible disk, hard disk, magnetic tape, or any other magnetic medium, magneto-optical medium, a CD-ROM, any other optical medium, a RAM, a PROM, an EPROM, a FLASH-EPROM, a solid state medium like a memory card, any other memory chip or cartridge, or any other medium from which a computer or like machine can read.

When the computer-readable media may be configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

While the invention is described in terms of exemplary embodiments, it should be appreciated that individual aspects of the invention may be separately claimed.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

In the drawings:

FIG. 1 is a perspective view of the application's “scan” screen with a QR code scanner displayed on a mobile computing device;

FIG. 2 is a perspective view of the application's “header” screen displayed on a mobile computing device;

FIG. 3 is an additional perspective view of the application's “header” screen with one of more graphical interfaces, which is displayed on a mobile computing device;

FIG. 4 displays a sample QR code where additional information has been added to the code, which is displayed on a mobile computing device;

FIG. 5 is a perspective view of the application's “codes” screen displayed on a mobile computing device;

FIG. 6 is a perspective view of the application's “print” screen displayed on a mobile computing device;

FIG. 7 is a perspective view of the application's “order” screen displayed on a mobile computing device.

FIG. 8 is a perspective view of the application's header screen, including “transfer ownership” and “user rights” prompts.

FIG. 9 is a perspective view of the application's “transfer rights” screen.

FIG. 10 is a perspective view of the application's “user rights” screen.

FIG. 11 describes a method for using a QR code as depicted in FIGS. 1-10.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all of the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

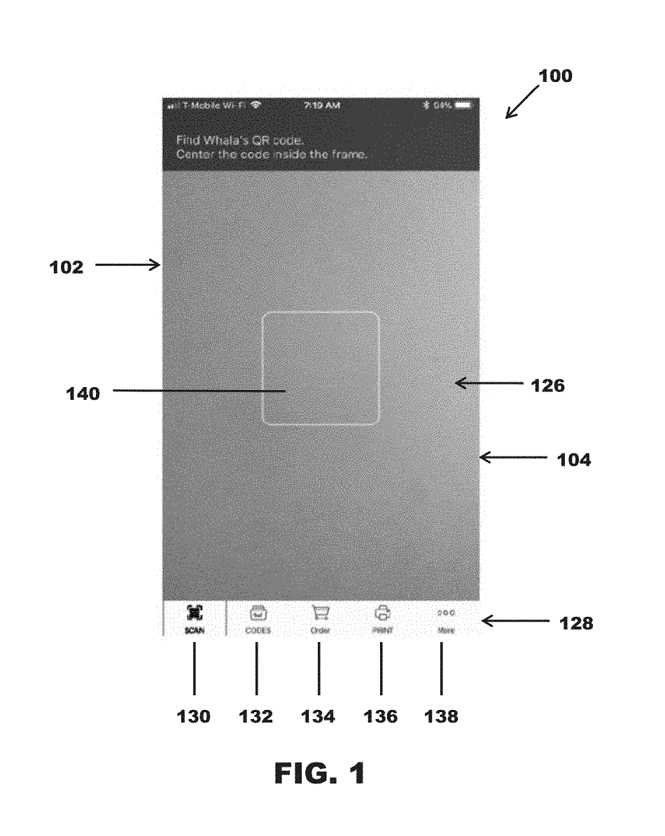

Referring now to the drawings, FIG. 1 depicts an embodiment of a system 100 according to a preferred embodiment, which comprises an application 102 that issues one or more QR codes 106 (not shown in FIG. 1) for individual use. Traditionally, QR Codes 106 are web-based, and content must be stored first on the Internet then the URL is printed into the QR code 106. In contrast, the application 102 described in FIG. 1 allows content to be entered from mobile computing devices 104 on to “blank” QR codes 106. As used herein, the term “blank” means that the URL to which the QR code 106 refers is an open framework to which a user may add content.

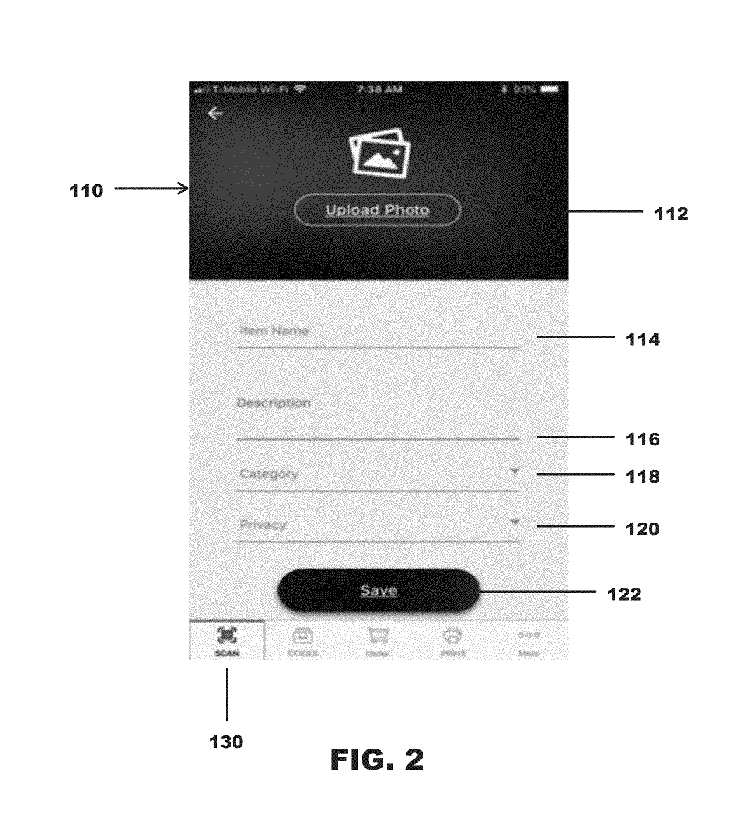

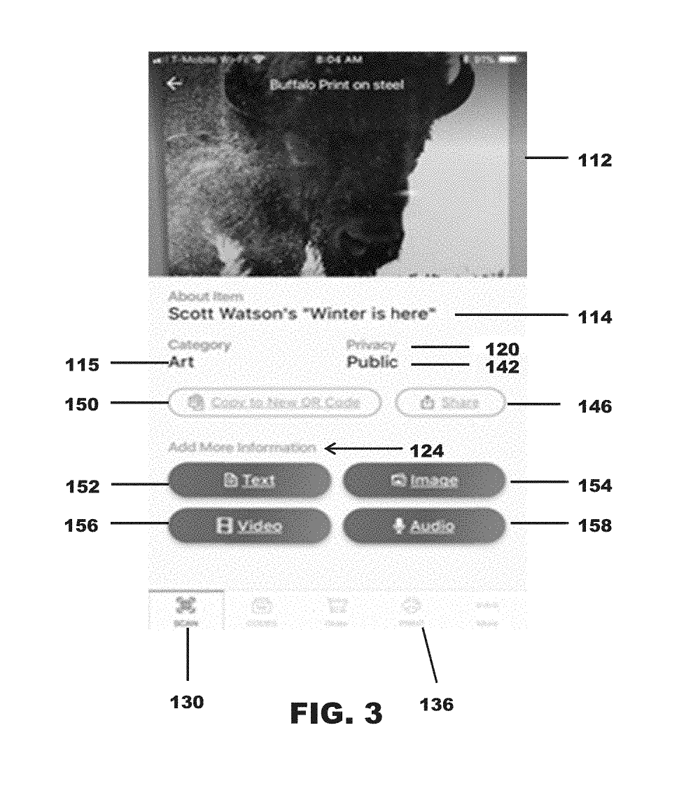

In one embodiment, the application 102 issues QR codes 106 comprising little to no content, which are saved to a server or equivalent data repository 108 (not shown in FIG. 1). In practice, a user may scan a QR code 106, fill out header information 110 (by way of example, description of the item the code is affixed to, including a picture of item 112, item name 114, description 116, item category 118 and whether code is public or private 120) and then save that information 122, as shown in FIGS. 2-3. After the header information 110 is saved 122, the application 102 allows users to add, edit or delete other types of content (text, video, pictures and audio) about the item 124 and store it back to the QR code 106. This will allow users to build personal or business histories of items, such as instructional content concerning the item's use or messaging related to the item, not simply document an item's existence (i.e., for insurance purposes).

After accessing and logging into the application 102, users are directed to a home screen with a QR code scanner 126, as depicted in FIG. 1. The user can also toggle between settings 128, such as “scan” 130, “codes” 132, “order” 134, “print” 136 and “more” 138, which are displayed on the bottom of the home screen 126 of the application 102, and are also preferably accessible from all screens/displays within the application 102. In one embodiment, the “more” 138 option comprises user name and password changes, tutorial, FAQ's, Contact screen and an option regarding Revoking code access. The application 102 is not intended to be limited by the settings identified above, and additional settings are available to a user in other embodiments.

In one preferred embodiment, the user would initiate the application 102 by using the “scan” 130 setting. The user centers the QR Code 106 inside the frame or scanner 140, as also shown in FIG. 1. The application 102 reads the QR code and, upon determining that the code is blank, immediately takes the user to the “header” 110 screen associated with the specific QR code 106, as shown in FIG. 2. The “header” 110 screen prompts a user to upload a photograph 112 and input information such as item name 114, description 116, category 118 and privacy 120. In one embodiment, a user may take a photograph 112 or upload an existing photograph 112 of an item of interest, which the issued QR code 106 is desired to be associated with. The user may name 114 or otherwise classify the item of interest, as desired. The user may also add a detailed text content description 116 of the item in the corresponding field on the application 102, as shown in FIG. 2. The user may also create categories 118 for the QR Code 106 (or other codes) and can assign the QR code 106 to a category 118. The user may select the privacy setting 120 as “Public” 142 or “Private” 144 or a hybrid of the two. If the user selects “Public” 142, any QR code reader will be able to display the content associated with the QR code 106, regardless of the nature of the device 104. If the user selects “Private” 144, only the owner of the code can access the content, unless they have “Shared” 146 the content privately via email (or otherwise invited other users). In certain embodiments, depending on the quality of QR code scanner 140, type of mobile device 104, lighting conditions, and the quality of the QR Code label, the QR code label will determine if a non-owner or unidentifiable scanning device can scan the QR code 106.

Once a user taps “Save” 122, as shown in FIG. 2, the user has “claimed” the particular QR code 106 and now owns it. The code is now available in the user's “Library” 148 of “Codes” 106 and can now accept other types of optional content to be linked to the QR code 106. The saved 122 QR code 106 may then be shared 146 with others, or transferred to another QR code 106. According to one embodiment, unique QR codes 106 are not assigned to any specific user until a user has “claimed” the code by saving 122 the “header” information 110 and thereby removing the unique QR code 106 from the database of unique QR codes 106 available for other users to “claim”. Whether a user prints 136 codes 106 at home or orders 134 codes through the application 102, the codes 106 are open for any user to “claim”.

Once a QR code 106 has been claimed and saved 122 by a user, the application 102 will display the “header” information 110 in one or more graphical interfaces, as shown in FIG. 3. This information 110 may be editable, meaning users will be able to change the picture 112, name 114, description 116 and category 118. Additionally, user can change a private code 144 to a public code 142, or vise-versa.

Once a QR code 106 has been “claimed”, the QR code 106 can be shared 146 with other users. For private codes 144, before configuring the sharing feature 146 described above, only the owner (user who claimed the unique QR code 106) may view the QR code 106. Sharing a private code 144 may be achieved via an email, which will only show the recipient the content 110, but does not provide the ability to edit or delete content 110. In another embodiment, the recipient (with the permission of the owner) will be able to add content 110 through sharing settings 146 configured by the user, but unable to delete or modify existing content. Semi-private or hybrid settings can also be provided via the application 102. As used in this application, “semi-private codes” and “hybrid codes” mean a private code 144 that the owner has shared with another user or provided another. In the menu at bottom of home screen “more” 138, as shown in FIG. 1, there is a selection for “Revoke All Private Code Access”. This selection is intended to keep any recipient who received a private code 144 from being able to access it again. Additionally, the recipient may forward the email to others, however, the application 102 will stop allowing access to the server if “Revoke All Private Code Access” is selected.

For sharing public codes 142, if “Public” code 142 is selected, the codes 106 may be texted, emailed, shared over Facebook, saved to Dropbox and other public sharing forms, depending on the configuration of the user's social media applications.

The application 102 may also copy (or transfer) a QR code 106 from one QR code 106 to another 106, as shown in FIG. 3. For example, in one preferred embodiment, some users will print 136 QR code 106 on plain paper for immediate use. Once the pre-printed 134 QR codes 106 arrives, the user may then select “Copy to New QR Code” 150, as shown in FIG. 3. When the user selects this option 150, the application 102 will be prompted to open the QR code scanner 140, and the user may scan the blank QR code 106 that he/she wishes to transfer the content 110 to and select “Save” 122. As another example: if a QR code 106 is damaged and the scanner 140 can no longer read the QR code 106, the user may reassign to a new QR code 106.

The application 102 may also share the code's content 110 with others, as shown in FIG. 3. If the code is “Private” 144, an owner of the QR code 106 can share the code's content 110 with another user on the application 102. In one embodiment the owner of the QR code 106 shares the code's content 110 via an email to another user on the application 102. In some embodiments, QR code 106 cannot be shared over social media. For example, a user may want their spouse to be able to read the QR code 106, but not their children. In other embodiments, if the code is “Public” 142, an owner can share the content 110 over most types of social media, including Facebook.

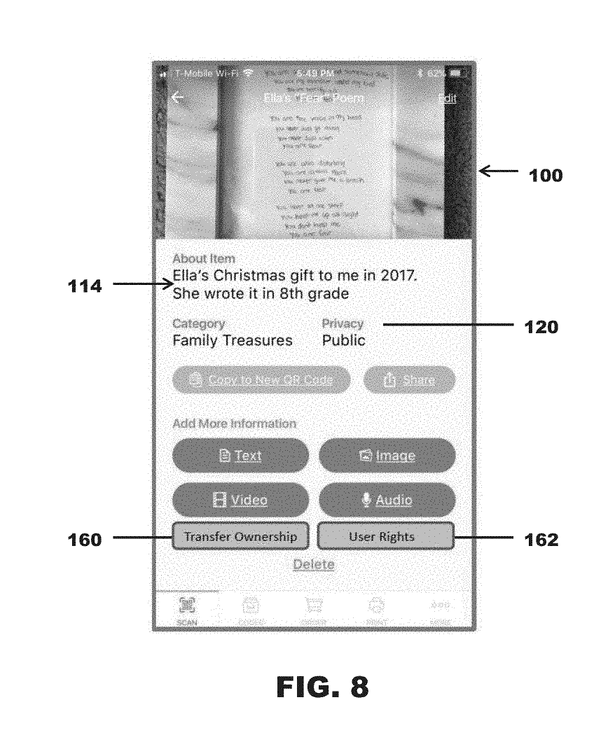

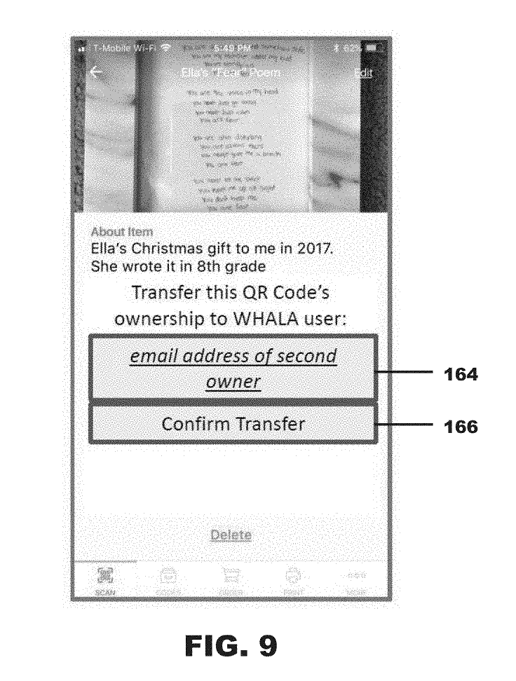

In an embodiment shown in FIGS. 8 and 9, a user who has “claimed” a particular QR code 106 may transfer ownership 160 of the QR code 106 to another user. As used herein, the terms “first owner” shall mean a transferor of the QR code 106 and “second owner” shall mean a transferee of the QR code 106. When the first owner selects “transfer ownership” 160 of the QR code 106 in question, the application 102 prompts the user to enter an email address of the second owner 164 (FIG. 9). Once the first owner provides the new owner's email address 164 and confirms transfer 166, the application 102 transfers the QR code 106 to the second owner. Upon transfer of the QR code 106 to the second owner, the application 102 will delete the QR code 106 as well as all saved information 122 and any content about the item 124 from the first owner's application 102. The privacy 120 for the transferred QR code 106 will be set as private 144, and the sharing feature 146 will be revoked, preventing any recipient who received a private code 144 from the first owner from being able to access the code again. Although the terms first owner and second owner are used herein to describe transfer of ownership of the QR code 106, one of ordinary skill will recognize that the invention is not limited to a single transfer from a first owner to a second owner.

In one preferred embodiment, a user has the ability to “Add More information” 124. In this embodiment, additional text fields 152, pictures 154, video 156 and/or audio files 158 can be added to build a continual history, chronology or story about the item 124 that the QR code 106 has been affixed to. Various examples of items that may be used with this system and method include, by way of example and not limitation, include: (1) A QR code 106 that is on a family heirloom, where video 156 and/or audio clips 158 have been added, such as a user's grandparents talking about the heirloom; (2) A QR code 106 that is on a furnace, where pictures 154 of every service call invoice has been added to the QR code 106; (3) A code that is on a birthday greeting card, where a video clip 156 has been added to show family and friends singing “Happy Birthday”; and (4) A QR code 106 that is on a piece of machinery, where written instructions 152 on how to use and/or troubleshoot the machine has been added.

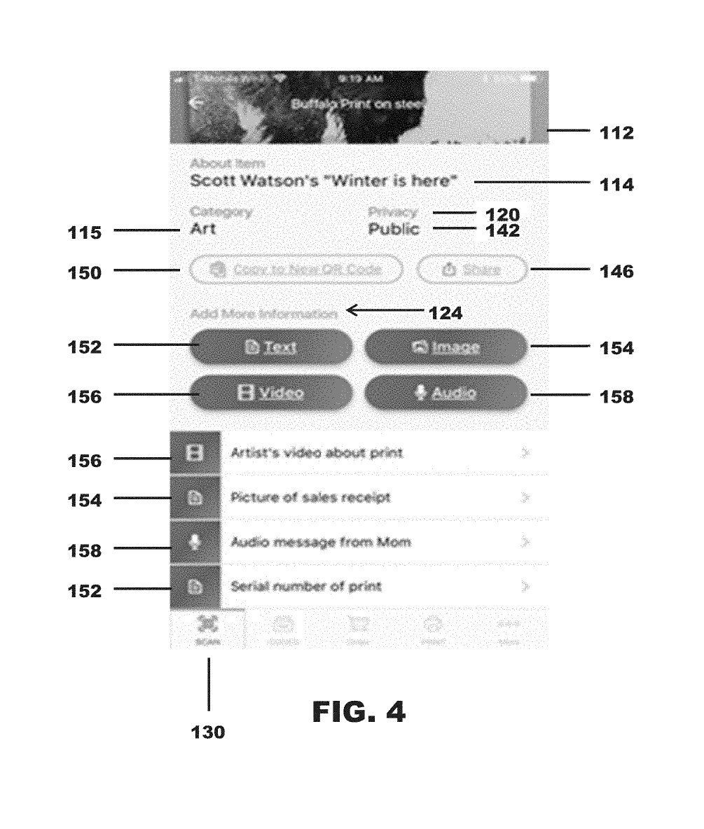

FIG. 4 depicts an example of sample QR code 106 with more information added 124. The added information content 124 will populate according to a filter (not shown) selected by the user, and display a video 156, audio 158, image 154 or text icon 152, for example. FIG. 4 depicts, for example, a QR code 106 affixed to a piece of art, where additional information 124 has been added, such as the artist's video 156 about the piece, the sales receipt 154, audio files 158 from family members, and the serial number 152. In this embodiment, the privacy 120 has been selected to “Public” 142, meaning that anyone can add/embed content 110 to the piece of art, without overwriting the existing content 110.

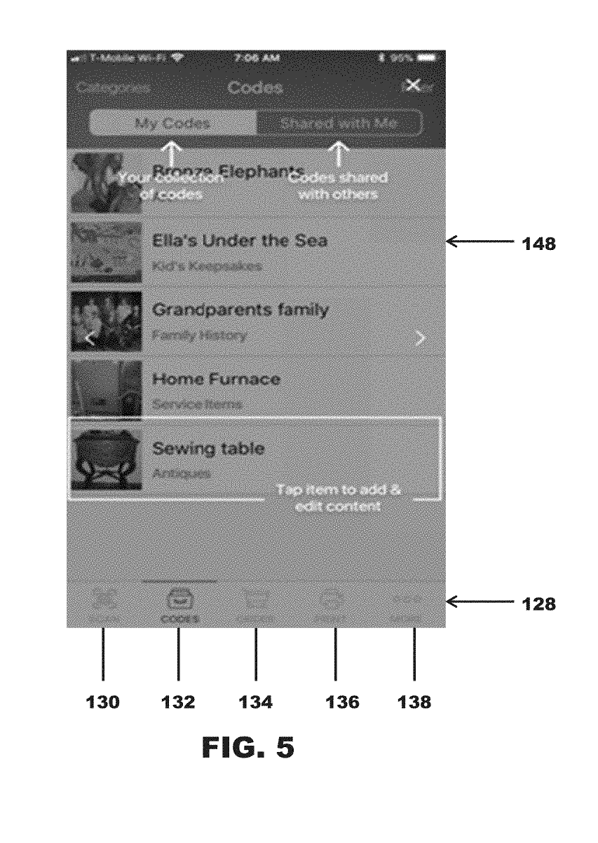

In one embodiment, a user may select the “codes” 132 option from the home screen of the application 102, as shown in FIG. 1. Selecting the “codes” 132 option on the menu 128 may bring a user to their library 148 of codes 106, as shown in FIG. 5. In this embodiment, a user can view all of their codes 106, view codes 106 shared 146 with others, and view codes that others have shared with the user. Categories and filters (sorting by category 118, public 142 or private 144, age or shared or not shared 146) are managed in this area of the application 102, as shown in FIG. 5. To view this level of information, a user may select a QR code 106 he/she wishes to view/edit/delete/share and the detail level information for this particular QR code 106 is displayed.

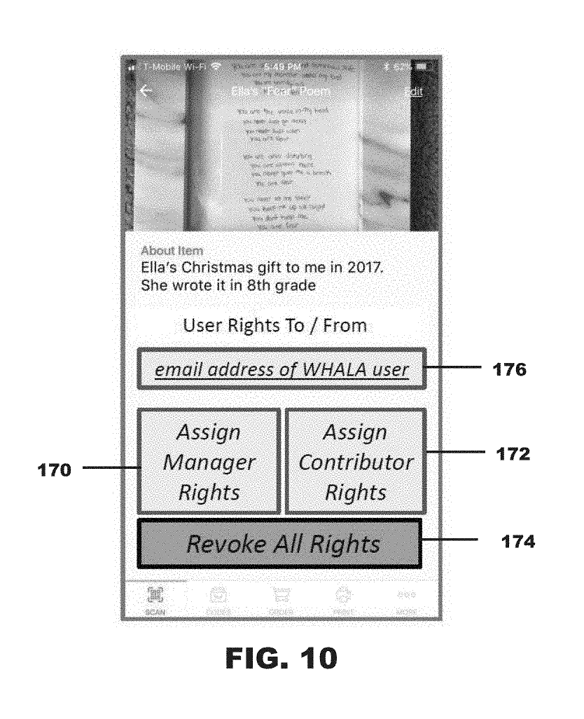

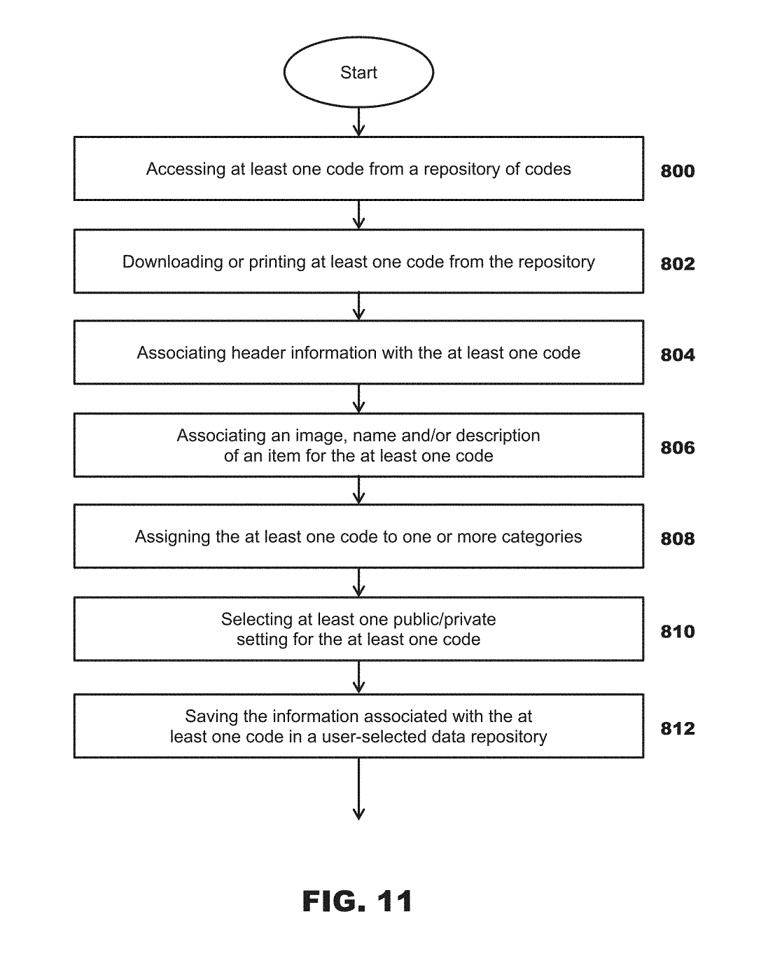

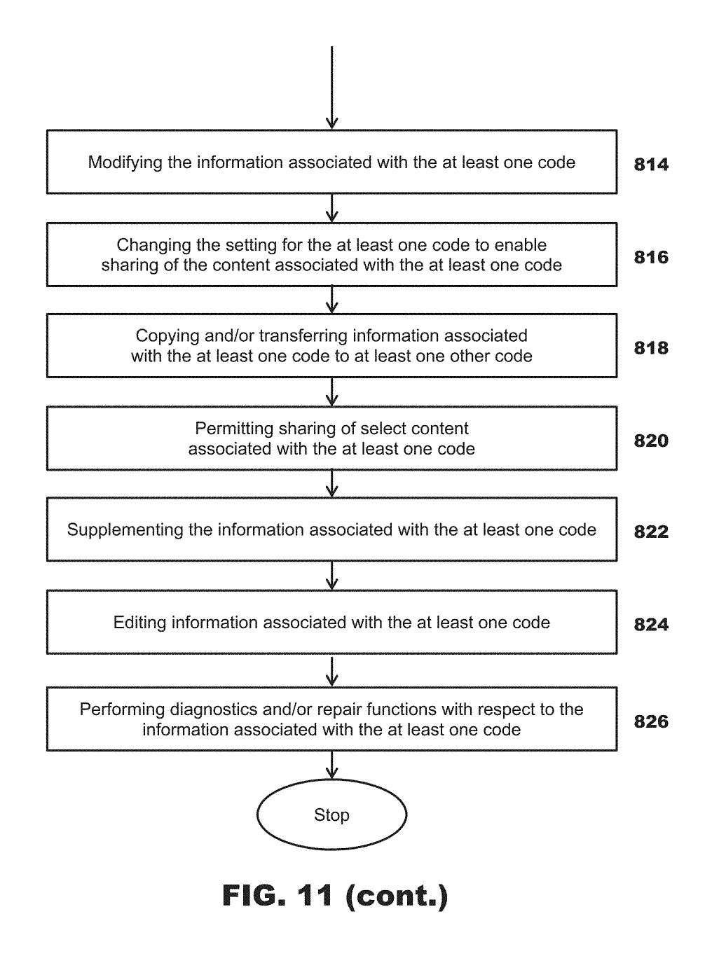

In an embodiment shown in FIGS. 8 and 10, the owner of a QR code 106 may assign varying degrees of user rights 162 to another user for private codes 144 and public codes 142. There are three levels of user rights in the illustrated embodiment, “owner rights” 168, “manager rights” 170, and “contributor rights” 172. “Owner rights” 168 allow the user to add, edit or delete content 110 from the QR code 106, transfer ownership of the code 160, assign user rights 162, revoke 174 all other rights, share 146 a code with others, change the privacy 120, change categories 118, and copy 150 information 110 to a new QR code 106. “Manager rights” 170 allow the user to add, edit or delete content 110 from the QR code 106, and to copy 150 information 110 to a new QR code 106. “Contributor rights” 172 allow the user to add information 110. Once the owner selects “assign user rights” 162 the application 102 prompts the user to enter an email address 176 of another user. Entering the email address 176 then allows the owner to select the degree of user rights 162 the owner would like to confer on the other user: either manager rights 170 or contributor rights 172. Alternatively, if the user enters the email address 176 and then selects “revoke all rights” 174 then all user rights will for the user denoted by the email address 176 in question.

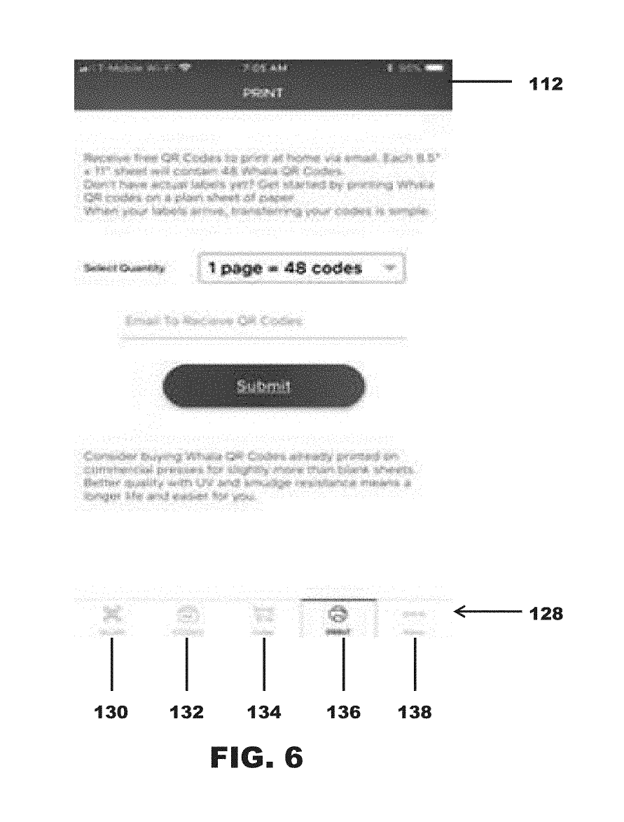

In a preferred embodiment, the application 106 offers users the ability to access QR codes 106 for printing 136 by supplying one or more QR codes 106 via a PDF attachment delivered to the user's email address, as shown in FIG. 6. Users can either print codes 136 on plain paper or specific size sheet labels in standard (8.5″×11″) sheets.

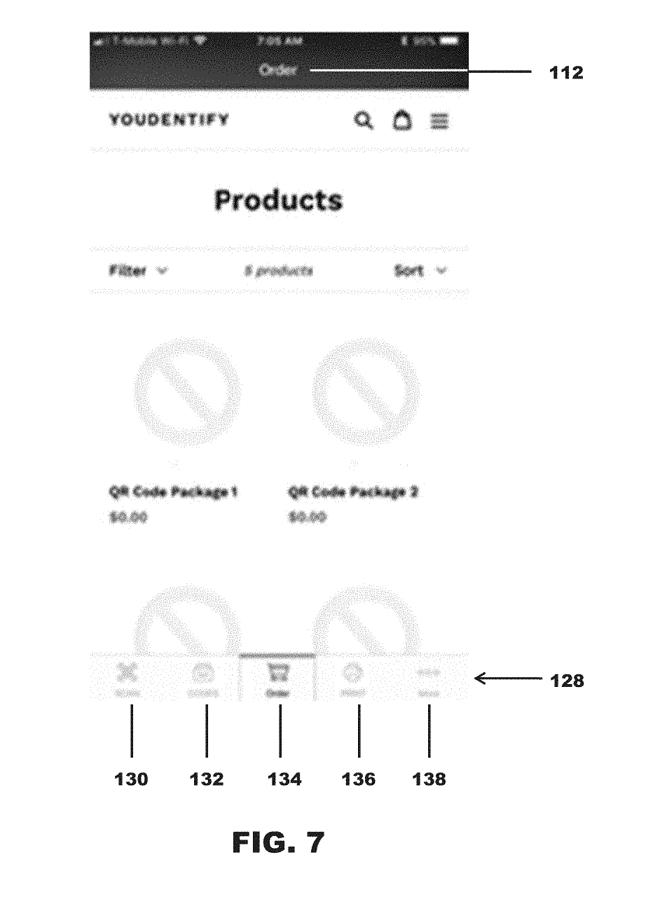

The application 102 also offers an option to purchase either blank sheet labels for printing or pre-printed QR Codes 106 to be delivered over the application or an associated website, as shown in FIG. 7.

The present invention also discloses a method where, in one embodiment, a user can associate a QR code with an item that stores information with the item by (1) accessing at least one code from a repository of codes 800, (2) downloading or printing at least one code from the repository 802, (3) associating header information with the at least one code 804, (4) associating an image, name and/or description of an item for the at least one code 806, (5) assign the at least one code to one or more categories 808, (6) select at least one public/private setting for the at least one code 810, and (7) saving the information associated with the at least one code in a user-selected data repository 812.

In one embodiment, a user may be provided with further method steps associated with the QR code associated with an item, including (8) modifying the information associated with the at least one code 814, (9) changing the setting for the at least one code to enable sharing of content associated with the at least one code 816, (10) copy and/or transfer information associated with at least one code to at least one other code 818, (11) permit sharing of select content associated with the at least one code 820, (12) supplement the information associated with the at least one code 822, (13) edit information associated with the at least one code 824, and (14) perform diagnostics and/or repair functions with respect to the information associated with the at least one code 826. Variations on these embodiments are contemplated, as is the order of the foregoing steps. In some embodiments, not all method steps may be utilized. In other embodiments, additional steps may also be incorporated.

In one embodiment, the system 100 is configured such that the user is not required to wait until receiving the QR code 106 to store information 110 concerning the item to the database. For example, the user may capture and upload a digital photograph 112 of the item in place of the QR code 106, thereby creating a unique record of the item. The application 102 uses image recognition technology to verify that an item featured in a subsequent photograph 112 is the item saved in the database by comparing “n” number of points of similarity between the photograph 112 connected with the item and the subsequent photograph, where n is a predetermined value set by the image recognition module. The image recognition technology can be any technology currently available or developed in the future.

While various embodiments of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g. the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A quick response code system for identifying an item of interest, comprising:
computational machinery configured to execute logic instructions via at least one processor;
a data repository comprising a plurality of records;
a code module comprising
a code generation tool comprising logic to generate a unique quick response code that associates the item of interest with a record in the data repository;
an information modification tool comprising logic to access, view, and modify information associated with the record; and
wherein the system prompts a first user to share the quick response code and the associated record with a second user who has interest in the item.

2. The quick response code system of claim 1, wherein the quick response code is reusable, may be removed from an item and may be reassigned to another item of interest.

3. The system of claim 1, wherein the system includes logic to permit selectively storing the quick response code on a public, private or semi-private data repository.

4. The system of claim 3, wherein only the second user may access the record associated with the quick response code when the quick response code is stored on a private data repository.

5. The system of claim 1, wherein the information associated with the record comprises header information including photographs, the name of the item and a description of the item.

6. The system of claim 1, further comprising a content modification tool including logic to access, view, and modify content about the item of interest.

7. The system of claim 6, wherein the content comprises text, video, pictures and audio.

8. The system of claim 1, wherein the system includes a transfer rights module comprising logic that prompts a user to transfer the quick response code from a first owner to a second owner.

9. The system of claim 1, wherein the quick response code generation tool initially generates quick response codes that are associated with blank records.

10. The system of claim 1, further comprising a user rights assignment module, comprising logic configured to allow the first user to grant the second user selective ability to access, view, and modify information associated with the record dependent upon the first user's selection of one of owner, manager and contributor rights for the second user.

11. The system of claim 10, wherein the user rights assignment module further comprises logic that grants the second user the ability to add, edit or delete any information associated with the record when the first user selects manager rights.

12. The system of claim 10, wherein the user rights assignment module further comprises logic that only grants the second user the ability to add information associated with the record when the first user selects contributor rights.

13. The system of claim 1, further comprising a scanner module comprising logic to scan the quick response code and search the data repository for the record associated with the item of interest.

14. A method of associating a quick response code with an item of interest that stores information with the item comprising:
accessing at least one quick response code from a repository of quick response codes;
associating information with the at least one code;
associating an image, name and/or description of an item for the at least one code;
saving the information associated with the at least one code in a data repository selected by a first user;
wherein the method further comprises a messaging framework comprising logic for achieving each of the steps of the method; and
wherein the steps are performed using specifically configured computational machinery having instructions stored on a processor.

15. The method of claim 14, further comprising
adding content, such as audio, video, photos, images or text, related to the item;

16. The method of claim 15, further comprising:
modifying the information associated with the at least one code;
supplementing the information associated with the at least one code; and
editing information associated with the at least one code.

17. The method of claim 14, further comprising:
selecting at least one public or private setting for the at least one code; and
permitting public, private or semi-private sharing of select content associated with the at least one code.

18. The method of claim 14, further comprising: copying and/or transferring information associated with at least one code to at least one other code.

19. The method of claim 14, further comprising granting a second user selective ability to access, view, and modify information associated with the code dependent upon the first user assigning of one of owner, manager and contributor rights to the second user.

20. The method of claim 14, further comprising transferring ownership of the at least one code to a second user.
